(19) United States
(12) Patent Application Publication
(10) Pub. No.: US 2012/0076519 A1
(43) Pub. Date: Mar. 29, 2012

(54) IMAGE FORMING APPARATUS

(75) Inventor: Yusuke Ishida, Toride-shi (JP)

(73) Assignee: CANON KABUSHIKI KAISHA, Tokyo (JP)

(21) Appl. No.: 13/235,231

(22) Filed: Sep. 16, 2011

(30) Foreign Application Priority Data
Sep. 28, 2010 (JP) 2010-216604

(51) Int. Cl. G03G 15/08

(52) U.S. Cl. 399/27; 399/49

(57) ABSTRACT

In an image forming apparatus including a plurality of image forming portions which respectively has a photosensitive drum, a charging roller, an exposure device, a development device, and a primary transfer roller which transfers a toner image developed to the drum to an intermediate transfer belt, for example, surface potential (On-image Vback) of a part overlapping a toner image to be formed at the image forming portion at the downstream of the belt movement direction from the image forming portion is set to be smaller than surface potential (i.e., Center Vback) of another part among surface potential (i.e., fog removal potential) of a non-image part of the photosensitive drum disposed to the image forming portion.

### BACKGROUND OF THE INVENTION

1. Field of the Invention

The present invention relates to an image forming apparatus such as a copying machine and a laser-beam printer utilizing an electrostatic recording system or an electrophotographic system in which an electrostatic image formed at an image bearing member is developed by utilizing developer having toner and carrier.

2. Description of the Related Art

In general, in an image forming apparatus of an electrophotographic system, image formation is performed with respective image forming processes such as charging, exposing, developing, transferring, fixing, and cleaning. That is, after a surface of an electrophotographic photoreceptor (hereinafter, called a photoreceptor) is evenly charged, an electrostatic image (i.e., a latent image) is formed by performing exposure according to image information. The electrostatic image is developed to be a toner image with toner and the toner image is transferred from the photoreceptor to a recording material such as paper. The photoreceptor after the toner image is transferred is cleaned as transfer residual toner remaining on the surface being eliminated. Meanwhile, the recording material to which the toner image is transferred has the toner image fixed to the surface thereof by being heated and pressurized. In this manner, the image formation is completed.

A two-component developer having mainly nonmagnetic toner and magnetic carrier mixed is widely utilized as the developer for the above-mentioned image forming apparatus (hereinafter, called a two-component development system) according to image quality enhancement and speed enhancement of recent full-color image forming apparatuses. In the development system utilizing the two-component developer, the developer containing toner and carrier is mixed by an agitating-mixing member and is supplied to a surface of a developer bearing member. A magnetic roll having a plurality of S-poles and N-poles alternately arranged is incorporated in the developer bearing member at a fixed position. The developer is to be in an ear-aligned state (hereinafter, called a magnetic brush) on the surface of the developer bearing member owing to magnetic force thereof. Then, the magnetic brush of the developer borne on the surface of the developer bearing member is contacted or closed to a surface of the photoreceptor and development bias voltage is applied between the developer bearing member and the photoreceptor. Accordingly, development is performed as the toner being stuck to the electrostatic image.

In a reversal development method, when the two-component developer is utilized, development is performed as the toner being stuck onto the photoreceptor after being separated from the carrier when electrostatic force due to potential difference between image part potential (i.e., Vl potential) on the photoreceptor and the development bias voltage (i.e., Vdc potential) applied onto the developer bearing member exceeds electrostatic force of sticking between the carrier and the toner. At that time, electrostatic force acts on the carrier on the developer bearing member as well to be stuck onto the photoreceptor with electrostatic force due to potential difference between the potential on the photoreceptor and the development bias voltage. However, the potential on the photoreceptor and the development bias voltage are controlled so that the carrier stays on the development roller owing to magnetic force of the developer bearing member. That is, the carrier is prevented from being stuck to the photoreceptor by exerting larger magnetic force than the electrostatic force acting to the carrier to be stuck onto the photoreceptor becomes the maximum at a part of a non-image part surface potential (i.e., Vd potential) in a normal state. Hereinafter, the potential difference between the non-image part surface potential (Vd potential) and the development bias voltage (i.e., Vdc potential) is called fog removal potential.

Meanwhile, in the development device utilizing the two-component developer, since a mixture ratio between toner and carrier (hereinafter, called toner density) in the development device is varied owing to toner consumption, it is required to continuously maintain toner density to be appropriate. When the toner density is inappropriate, there may be a case that imaging failure such as image density variation, fog and carrier sticking occurs. Accordingly, it is important to appropriately control the toner density to perform image formation stably in high quality. For example, there may be a toner supplement control method such as a patch detection method (i.e., an image density detection method) and a method utilizing a toner density detection unit as being a light detection method or an inductance detection method.

In the following, issues with utilizing the above-mentioned two-component development system will be described.

In the above-mentioned two-component development device, the fog removal potential is set so that toner and carrier are unlikely to be developed to a non-image part. Hereinafter, a phenomenon that toner is developed to a non-image part is called toner fogging and a phenomenon that carrier is developed to a non-image part is called carrier sticking. The above is intended to suppress sticking of toner and carrier to a non-image part owing to the fog removal potential since toner and carrier in the development device respectively have determined polarities.

However, it is difficult to completely eliminate the above-mentioned toner fogging and carrier sticking. In particular, when carrier sticking occurs even with a slight amount, there may be a case that following issues occur.

It is assumed that a green image is formed by superimposing yellow and cyan, for example, in a tandem type image forming apparatus in which toner images are sequentially formed in yellow (at a first station), magenta (at a second station), cyan (at a third station), and black (at a fourth station).

First, a yellow image is formed at the yellow station and is transferred to a transfer-receiving member. Next, the yellow toner image formed on the transfer-receiving member passes through the magenta station. At that time, when carrier sticking occurs onto the image bearing member at the magenta station, occurring carrier is stuck onto the yellow toner image. Then, the yellow toner image on the transfer-receiving member arrives at the cyan station, the cyan toner image is transferred onto the yellow toner image on the transfer-receiving member. However, at that time, since the carrier is stuck onto the yellow toner image, transfer failure occurs with cyan toner corresponding to a position at which the carrier presents. Accordingly, there may be a case that a while-spot-like part (hereinafter, called a white spot) appears on an output green image at a position to which cyan toner is not transferred.

Normally, when a toner image is transferred onto the transfer-receiving member, the toner on the image bearing member is transferred to the transfer-receiving member as generating transfer electric field in a toner transferring direction to the transfer-receiving member. Here, the toner transferring direction depends on the polarity of the toner and the direction of the transfer electric field. Since the carrier has the opposite polarity to that of the toner, the carrier receives force in the direction to be apart from the transfer-receiving member owing to the transfer electric field even when the above carrier sticking occurs. Accordingly, the carrier is unlikely to be transferred onto the transfer-receiving member.

However, when the yellow toner image is overlapped with the carrier sticking position of magenta as described above, the carrier occurring at the magenta station and the yellow toner image have mutually opposite polarities. Accordingly, the yellow toner and the carrier are mutually attracted with Coulomb force. The force causes transferring of the carrier occurring at the magenta station onto the yellow toner image.

In most cases, the above-mentioned phenomenon occurs with influence of carrier sticking occurring at the magenta station when image formation is performed by superimposing toner images of the yellow station and the cyan station onto the transfer-receiving member. However, there may be a case that a white spot is generated even in the following case.

For example, when a toner charging amount becomes large with variation of toner density in the development device according to usage of the image forming apparatus, the carrier sticking amount is worsened. In this case, for example, when a single color image formation in cyan is performed, stuck carrier occurring at a non-image formation area of the yellow and magenta stations is partially transferred to the transfer-receiving member. Accordingly, there may be a case of white spot occurrence similarly at an overlapped position of the cyan toner image part and the carrier sticking occurrence position.

To solve the above issues, Japanese Patent Laid-open No. 2006-119380 discusses an image forming apparatus in which presence or absence of carrier sticking on a photoreceptor is detected by an optical sensor and the photoreceptor and a transfer device are separated according to the detection result. There are also various proposals of image forming apparatuses in which carrier sticking on a photoreceptor is detected with an optical detection unit. However, such optical detection unit is extremely poor in detection accuracy of carrier sticking, and further, is incapable of detecting over the entire area in a main scanning direction of the photoreceptor. Accordingly, the above is not useful as having various issues that the optical sensor can detect carrier only at the mounted position and the like.

Further, Japanese Patent Laid-open No. 5-66678 discusses an image forming apparatus in which a roller-shaped rotatable electric magnet is disposed at a downstream side in a movement direction of a photoreceptor and carrier stuck onto the photoreceptor is eliminated as being sucked. However, this is to simply eliminate carrier from the photoreceptor. Owing to limitation of recovery capability, there may be a possibility that stuck carrier cannot be recovered when stuck carrier is further increased depending on development conditions. Further, the above is not to fundamentally suppress carrier sticking from the development device.

In addition, since the above proposals utilize the optical sensor or the electric magnet roller, there is an issue of required space for mounting the optical sensor or the electric magnet roller and further cost increase.

### SUMMARY OF THE INVENTION

To address the issues disclosed herein, the present invention provides an image forming apparatus capable of suppressing a decrease in image quality due to carrier sticking while suppressing toner fogging without newly increasing part count.

An image forming apparatus according to the present invention includes a plurality of image forming portions, each of which respectively include an image bearing member, an electrostatic image forming device which forms an electrostatic image on a surface of the image bearing member, a development device that develops the electrostatic image of the image bearing member by utilizing developer having toner and carrier, and a transfer device that transfers a toner image developed by the image bearing member to a transfer-receiving member, the plurality of image forming portions including a first image forming portion and a second forming portion that is arranged at a downstream side of an image conveyance direction from the first image forming portion, and a controlling portion that is capable of performing a mode to control potential of the image bearing member at the first image forming portion so that an absolute value of a surface potential of at least a part of a first area is to be smaller than that of a surface potential of a second area, wherein the first area denotes an area to which a toner image is not to be formed at the first image forming portion and corresponding to an area to which a toner image is to be formed at the second image forming portion, and that the second area denotes an area corresponding to an area to which any toner image is not formed at both the first image forming portion and the second image forming portion among the surface of the image bearing member at the first image forming portion.

Further features of the present invention will become apparent from the following description of exemplary embodiments with reference to the attached drawings.

### BRIEF DESCRIPTION OF THE DRAWINGS

FIG. 1 is a schematic structural view of an example of an image forming apparatus;

FIG. 2 is a schematic sectional view illustrating a development device and a toner supplement device according to a first embodiment;

FIG. 3 is an explanatory view for describing a potential setting at a photosensitive drum;

FIG. 4 is an explanatory view of operation processes of the image forming apparatus;

FIG. 5 is a graph indicating a relation between fog removal potential and respective toner fogging and carrier sticking amounts;

FIG. 6A is a view illustrating an aspect when an image is formed on a recording material and FIG. 6B is an explanatory view of potential setting at the photosensitive drum;

FIG. 7 is a schematic sectional view illustrating a development device and a toner supplement device according to a second embodiment;

FIG. 8 is a perspective view of a magnetic permeability sensor;

FIG. 9 is a graph for describing the magnetic permeability sensor;

FIG. 10A is a graph indicating relation between a toner fogging amount and fog removal potential and FIG. 10B is a graph indicating relation between a carrier sticking amount and the fog removal potential;

FIG. 11 is a flowchart for determining fog removal potential according to the second embodiment; and

FIG. 12 is a flowchart for determining fog removal potential according to a third embodiment.

### DESCRIPTION OF THE EMBODIMENTS

In the following, exemplary embodiments of will be described in detail as examples with reference to the drawings. Here, dimensions, materials, shapes, and relative arrangement described in the following embodiments are to be appropriately modified according to a structure of a device to which the present invention is applied and various conditions. Therefore, unless otherwise specified, the scope of the present embodiments is not intended to be limited thereto.

### First Embodiment

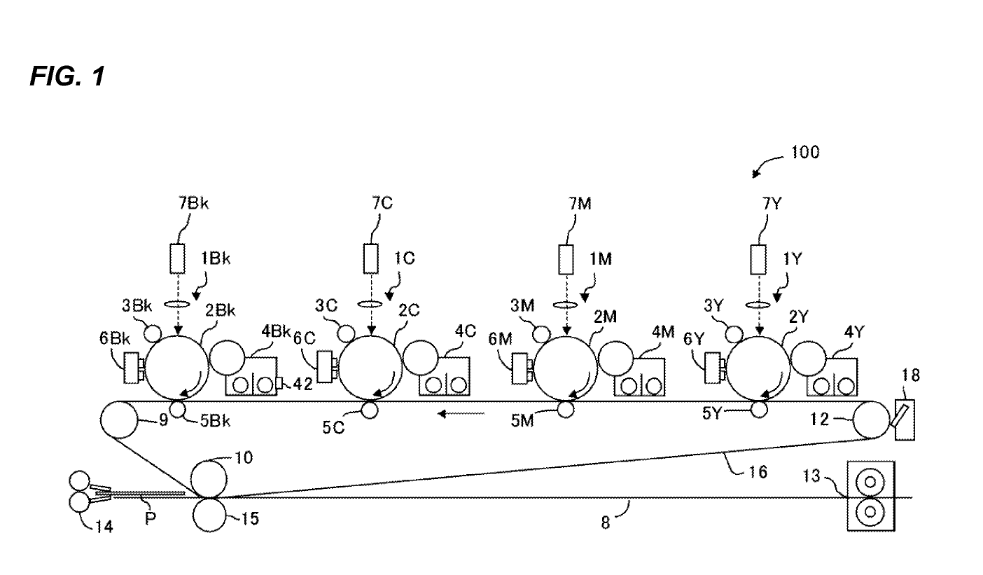

The entire structure and operation of an image forming apparatus according to the present embodiment will be described with reference to FIG. 1. FIG. 1 is a schematic structural view of an image forming apparatus 100 according to the present embodiment. The image forming apparatus 100 includes a plurality of image forming portions aligned along a movement direction of a transfer-receiving member. Here, the image forming apparatus is exemplified by a full-color printer of an electrophotographic system having four image forming portions 1Y, 1M, 1C, 1Bk which are arranged corresponding to four colors of yellow, magenta, cyan, and black. However, the image forming apparatus as disclosed herein is not limited to a full-color printer of an electrophotographic system. In the following description, the image forming portions 1Y, 1M, 1C, 1Bk are also called as first, second, third, and fourth stations or yellow, magenta, cyan, and black stations in the order from the upstream of the movement direction of the transfer-receiving member. Further, the transfer-receiving member is exemplified by an intermediate transfer belt.

The image forming apparatus 100 is capable of forming a four-color, full-color image on a recording material (e.g., a recording sheet, a plastic film, a cloth to name but a few) according to a transmitted image signal. Here, for example, the image signal is transmitted from a host device such as a personal computer which is communicably connected to an image forming apparatus body or to an original reading device (not illustrated) connected to the image forming apparatus body. Toner images respectively formed on electrophotographic photoreceptors 2Y, 2M, 2C, 2Bk as image bearing members at the image forming portions 1Y, 1M, 1C, 1Bk are transferred onto an intermediate transfer belt 16 as the transfer-receiving member, and subsequently, transferred onto a recording material P which is conveyed by a recording material bearing member 8.

Here, in the present embodiment, the four image forming portions 1Y, 1M, 1C, 1Bk arranged in the image forming apparatus 100 are substantially the same except for developing color difference. In the following, when discrimination thereamong is not particularly required, suffixes Y, M, C, Bk to be added to an element to indicate which image forming portion the element belongs to are not described and description is made in general.

The image forming portion 1 is provided with a cylindrical photoreceptor as the image bearing member, that is, a photosensitive drum 2. The photosensitive drum 2 is rotationally driven in an arrow direction in FIG. 1. A charging roller 3 as a charging portion, a development device (i.e., a developing device) 4 as a development unit, a primary transfer roller 5, and a secondary transfer roller 15 as a transfer portion (i.e., a transfer device), a secondary transfer opposing roller 10, and a cleaning device 6 as a cleaning unit are arranged around the photosensitive drum 2. A laser scanner (i.e., an electrostatic image forming device) 7 as an exposure unit is arranged above the photosensitive drum 2 in FIG. 1. Further, the intermediate transfer belt 16 as the transfer-receiving member is arranged as being opposed to the photosensitive drum 2 of each image forming portion 1. The intermediate transfer belt 16 is tensionally arranged around a drive roller 9, the secondary transfer opposing roller 10, and a driven roller 11. The intermediate transfer belt 16 is moved as turning around in the arrow direction in FIG. 1 owing to driving of the drive roller 9 and conveys a toner image to a contact portion (i.e., a secondary transfer portion) with the recording material P. Subsequently, after being transferred to the recording material P from the intermediate transfer belt 16, the toner image is thermally fixed to the recording material P by a fixing device 13.

As an example, the following description is made on four-color full-color image formation. First, when an image forming operation is started, the surface of the rotating photosensitive drum 2 is evenly charged by the charging roller 3. At that time, charge bias is applied to the charging roller 3 by a charge bias power source. Next, the photosensitive drum 2 is exposed with laser light which corresponds to an image signal transmitted from the exposure device 7. Accordingly, an electrostatic image (i.e., a latent image) corresponding to the image signal is formed on the photosensitive drum 2. The electrostatic image on the photosensitive drum 2 is visualized with toner accommodated in the development device 4 so as to be a visible image. The present embodiment adopts a reversal development method to attach toner to bright section potential exposed by laser light.

The toner image is formed on the photosensitive drum 2 by the development device 4 and is primarily transferred onto the intermediate transfer belt 16. The toner remained on the surface of the photosensitive drum 2 after the primary transfer (i.e., transfer residual toner) is eliminated by the cleaning device 6.

This operation is sequentially performed for yellow, magenta, cyan, and black so that four colors of toner images are superimposed on the intermediate transfer belt 16. Thereafter, the recording material P accommodated in a recording material accommodating cassette (not illustrated) is conveyed by a feeding roller 14 as a feeding unit and the recording material bearing member 8 as a conveying unit as being synchronized with toner image formation timing. Then, the four-color toner image on the intermediate transfer belt 16 is secondarily transferred at once onto the recording material P borne on the recording material bearing member 8 by applying secondary transfer bias to the secondary transfer roller 15.

Next, the recording material P is separated from the recording material bearing member 8 and is conveyed to the fixing device 13 as a fixing unit. The toner on the recording material P is melted and mixed as it is being heated and pressurized by the fixing device 13 so as to be a full-color permanent image. Consequently, the recording material P is discharged to the outside of the apparatus.

Further, remaining toner at the intermediate transfer belt 16 failing to be transferred at the secondary transfer portion at which the secondary transfer roller 15 and the secondary transfer opposing roller 10 are faced is eliminated by an intermediate transfer belt cleaner 18. The intermediate transfer belt cleaner 18 is contacted to a driven roller 11 via the intermediate transfer belt 16. In this manner, a series of operations is completed.

Here, it is also possible to form an image of a desired single color or plural colors by utilizing only the desired image forming portion or portions.

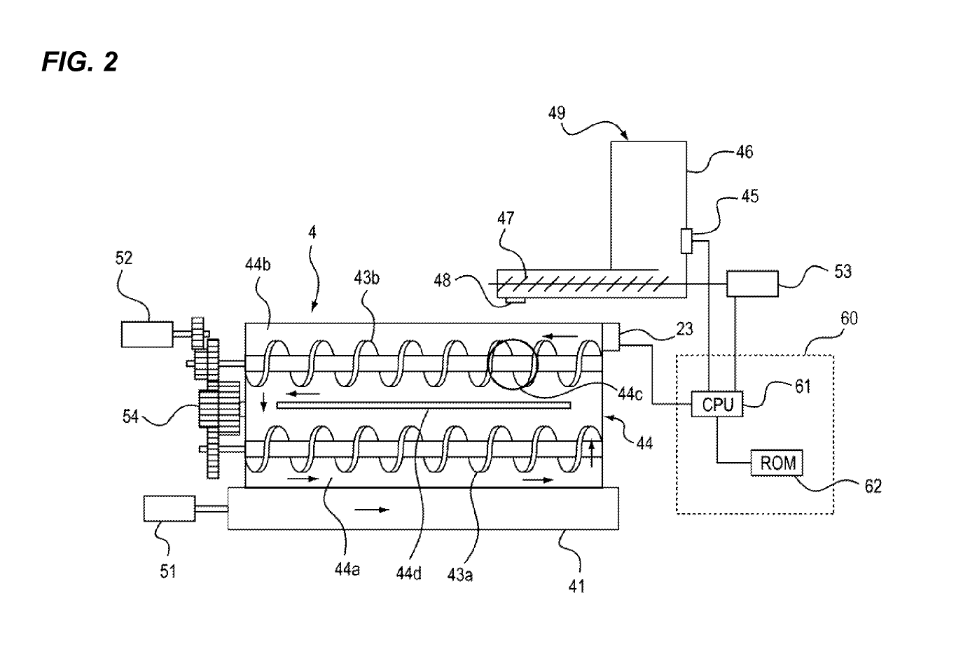

Next, description will be made on the development device 4 and a toner supplement device 49 which supplements toner thereto with reference to FIG. 2. In the present embodiment, structures of development devices for yellow, magenta, cyan, and black are the same except for developing color difference. In FIG. 2, the development device 4 is illustrated as a plain view, as viewed from the above of FIG. 1 and the toner supplement device 49 is illustrated as a sectional view as viewed along an axial line direction of the photosensitive drum 2 (i.e., the direction perpendicular to a surface movement direction).

The development device 4 includes a development container (i.e., a development device body) 44 which accommodates two-component developer having nonmagnetic toner particles (i.e., toner) and magnetic carrier particles (i.e., carrier) as major components.

The toner includes colored resin particles having binding resin, colorant, and other additive if required, and a colored particle to which external additive such as colloidal silica fine powders is externally added. The toner is polyester resin having a negative electrostatic propensity manufactured with a polymerization method of which mean volume diameter is preferably 5 μm or more and 8 μm or less. In the present embodiment, the mean volume diameter is 6.2 μm.

It is preferably possible to utilize metal such as iron having surfaces that may be oxidized or unoxidized, nickel, cobalt, manganese, chrome and rare earth, alloy thereof, or oxide ferrite, for example. The method of manufacturing the above magnetic particles is not limited to any particular method. The weighted mean diameter of the carrier may be between 20 and 50 μm, and preferably, between 30 and 40 μm and the resistivity thereof is about 10⁷ Ω·cm or larger, and preferably, is 10⁸ Ω·cm or larger. In the present embodiment, the resistivity is approximately 10⁸ Ω·cm. In the present embodiment, as the magnetic carrier having a low specific gravity, magnetic metallic oxide, and nonmagnetic metallic oxide with phenol binder resin are mixed at a predetermined ratio, and resin magnetic carrier manufactured with a polymerization method is utilized. Here, the mean volume diameter is 35 μm, real density is between 3.6 to 3.7 g/cm³, and magnetization quantity is 53 A·m²/kg.

Two screws, a first agitating-conveying screw 43a and a second agitating-conveying screw 43b, functioning as developer agitating-conveying members, are arranged in the development container 44. A part of the development container 44 facing the photosensitive drum 2 is partially opened. A development sleeve 41, functioning as a developer bearing member, is rotatably arranged and partially exposed from the opening portion. A magnet roll (not illustrated), functioning as a magnetic field generating unit, is arranged as being fixed to the inside of the development sleeve 41. The magnet roll includes a plurality of magnetic poles in the circumferential direction and attracts developer on the development sleeve 41 by a magnetic force and forms a magnetic brush with developer at the development portion facing the photosensitive drum 2.

The development sleeve 41 and the first and second agitating-conveying screws 43a, 43b are arranged in parallel to one another. Further, the development sleeve 41 and the first and second agitating-conveying screws 43a, 43b are arranged in parallel to the axial line direction of the photosensitive drum 2. The inside of the development container 44 is divided into a first room (i.e., a development room) 44a and a second room (i.e., an agitation room) 44b by a partition wall 44d. The development room 44a and the agitating room 44b are in mutual communication at both end parts in the longitudinal direction of the development container 44.

The first agitating-conveying screw 43a is arranged in the development room 44a and the second agitating-conveying screw 43b is arranged in the agitation room 44b. The first and second agitating-conveying screws 43a, 43b are rotatably driven in the same direction via the rotation of a motor 52 via a gear train 54. As a result of the rotation, the developer in the agitation room 44b is moved toward one side in the longitudinal direction of FIG. 2 as being agitated by the second agitating-conveying screw 43b and is moved into the development room 44a via a communication portion. Meanwhile, the developer in the development room 44a is moved toward the other side in the longitudinal direction of FIG. 2 as being agitated by the first agitating-conveying screw 43a and is moved into the agitation room 44b via a communication portion. That is, the developer is conveyed to be circulated within the development container 44 as being agitated by the two screws of the first and second agitating-conveying screws 43a, 43b.

The toner in the developer is charged by the agitation conveyance as described herein. In the present embodiment, toner supplement is performed through a toner supplement port 44c which is arranged at the upper part in the agitation room 44b as the upstream end part side of the developer conveyance direction. A window portion for viewing inside is arranged at an end part (i.e., the upstream end part of the developer conveyance direction) of the agitation room 44b in the longitudinal direction of FIG. 2.

The development sleeve 41 is rotationally driven by a motor 51. Owing to the rotation of the development sleeve 41, the developer laminarly spread on the surface thereof by a regulation blade (not illustrated) is conveyed to the development portion facing the photosensitive drum 2. At the development portion, the developer on the development sleeve 41 forms a magnetic brush to be contacted or to be closed to the surface of the photosensitive drum 2 as being ear-aligned with magnetic force of the magnetic roll. The toner is supplied to the electrostatic image on the photosensitive drum 2 from the developer (i.e., two-component developer) which is conveyed to the development portion as described above. Accordingly, the toner is attached selectively to an image part of the electrostatic image, so that the electrostatic image is developed as a toner image. More specifically, development bias having AC voltage and DC voltage superimposed is applied to the development sleeve 41 by a development bias applying power source (not illustrated) when the electrostatic image on the photosensitive drum 2 arrives at the development portion. At that time, the development sleeve 41 is rotationally driven by the motor 51 and the toner in the developer is transferred onto the photosensitive drum 2 according to the electrostatic image on the surface of the photosensitive drum 2 owing to the above-mentioned developer bias.

With the above-mentioned development operation, the toner in the two-component developer is consumed. Accordingly, toner density of the developer in the development container 44 is gradually lowered. Then, the toner is supplemented to the development container 44 by the toner supplement device 49. The toner supplement device 49 includes a toner container (i.e., a toner supplement bath or a toner storage portion) 46 accommodating toner which is to be supplied to the development device 4. A toner discharge port 48 is arranged at the lower end of the toner container 46 as in FIG. 2. The toner discharge port 48 is connected to the toner supplement port 44c of the development device 4. Further, the toner container 46 is provided with a toner supplement screw 47 as a toner supplement unit to convey the toner toward the toner discharge port 48. The toner supplement screw 47 is rotationally driven by a motor 53.

The rotation of the motor 53 is controlled by a CPU (i.e., a controlling portion) 61 of an engine controlling portion 60 which is provided to the image forming apparatus body. Correspondence relation is previously obtained through experiments and the like between rotation time of the motor 53 in a state that a predetermined amount of the toner is accommodated in the toner container 46 and an amount of the toner to be supplemented into the development container 44 via the toner discharge port 48 (i.e., the toner supplement port 44c) by the toner supplement screw 47. The result thereof is stored in a ROM 62 connected to the CPU 61 (or in the CPU 61) as table data, for example. That is, the CPU 61 adjusts the supplement amount of the toner against the development container 44 by controlling (i.e., adjusting) the rotation time of the motor 53.

The present embodiment adopts a readable and writable RP-ROM as a memory device 23 disposed to the development device 4. The memory device 23 is electrically connected to the CPU 61 by setting the development device 4 to a printer so that image formation processing information of the development device 4 can be read and written from the printer side.

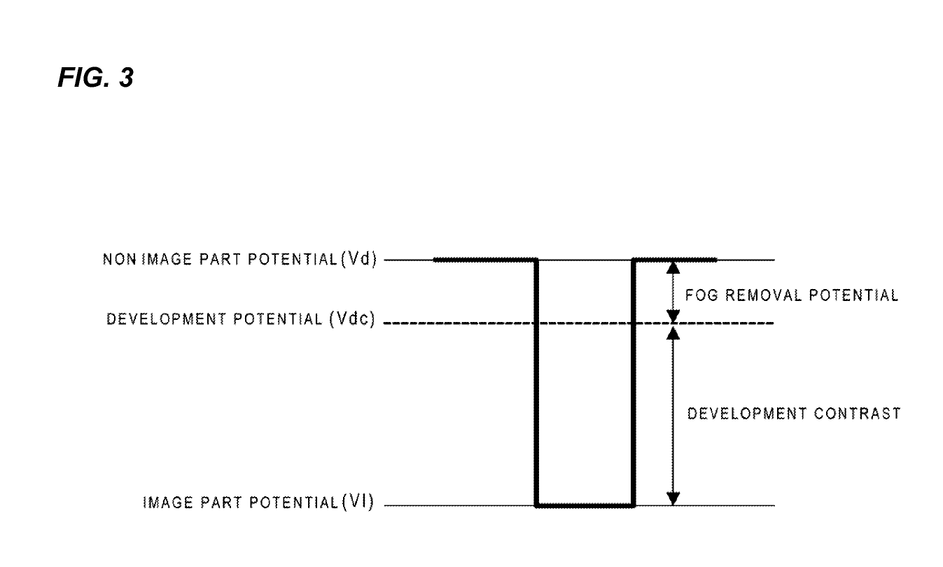

Here, FIG. 3 illustrates relation between potentials of an image part and a non-image part of the photosensitive drum (i.e., the image bearing member) and the bias to be applied to the development sleeve (i.e., the developer bearing member). As described above, the electrostatic image is visualized (i.e., is to be a toner image) by developing with negative toner against the exposed part on the photosensitive drum which is negatively charged. FIG. 3 schematically illustrates a potential (Vl) at the image part and a potential (Vd) at the non-image part on the photosensitive drum and an absolute value (Vdc) of a DC value of the development bias to be applied to the development sleeve, respectively.

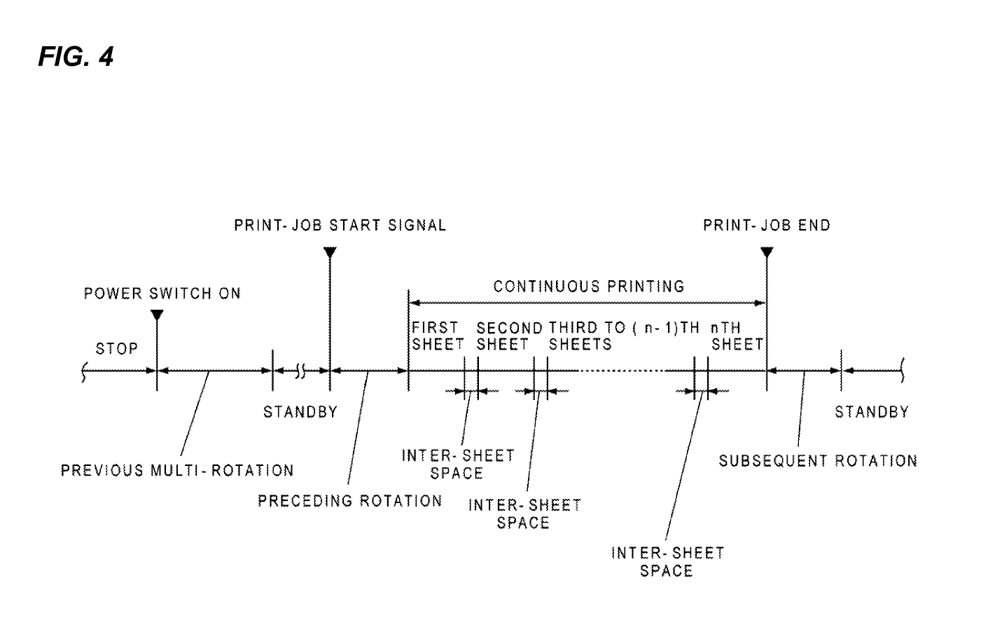

Here, an operation process chart of the image forming apparatus is illustrated in FIG. 4. In the following, each operation process will be described in sequence.

A previous multi-rotation process is for a start-up (i.e., activation) operation period (i.e., a warm-up period) of the image forming apparatus. When a main power switch of the image forming apparatus is turned on, a main motor of the image forming apparatus is activated and necessary preparation operation of process devices is performed.

During a standby process after the predetermined start-up operation period, operation of the main motor is stopped and the image forming apparatus is maintained at a standby (i.e., waiting) state until a print-job start signal is output.

A preceding rotation process is for a period to perform necessary print-job preceding operation of the process devices as re-actuating the main motor based on input of the print-job start signal. More practically, it is performed in the following order.

1. Receiving the print-job start signal by the image forming apparatus,
2. Expanding the image with a formatter (expanding time varies according to a data amount of the image and processing speed of the formatter), and
3. Starting the preceding rotation process.

Here, when the print-job start signal is output during the previous multi-rotation process, the preceding rotation process is subsequently performed after the previous multi-rotation process is completed without the standby process.

To perform a print-job, the above-mentioned image forming process is performed subsequently after the predetermined preceding rotation process is completed and an image-formed recording material is output. To perform a continuous print-job, the above-mentioned image forming process is repeated and image-formed recording materials of the predetermined number of sheets are sequentially output.

An inter-sheet process being a spacing process between a rear end of one recording material P and a front end of a subsequent recording material P is a non-sheet passing state period at the transfer portion and the fixing device.

In a subsequent rotation process, the main motor is subsequently driven for a predetermined time even after the image-formed recording material is output in the print-job of only one sheet or after the last image-formed recording material is output in the continuous print-job. In this manner, necessary print-job subsequent operation of the process devices is performed in this period.

During a standby process after the predetermined subsequent rotation process is completed, operation of the main motor is stopped and the image forming apparatus is maintained at the standby (i.e., waiting) state until the next print-job start signal is output.

In the above operation processes, print-job performing is in an image forming period and the previous multi-rotation process, the preceding rotation process, the inter-sheet process and the subsequent rotation process are in a non-image forming period.

Here, the non-image forming period denotes at least one of the previous multi-rotation process, the preceding rotation process, the inter-sheet process and the subsequent rotation process, and further, at least a predetermined time in the processes.

In the above-mentioned non-image forming period, predetermined voltage is applied to the charging roller 3 and the development sleeve 41 at least while the photosensitive drum 2 and the development sleeve 41 are rotated. Accordingly, predetermined potential difference between the photosensitive drum 2 and the development sleeve 41 (i.e., fog removal potential) is arranged. This is to suppress occurrence of toner fogging and carrier sticking caused by rotation of the photosensitive drum and the development sleeve in the non-image forming period. Here, the fog removal potential in the non-image forming period is set to be similar to that in the normal image forming period (i.e., an imaging period). Specifically, the surface potential (Vd potential) of the photosensitive drum 2, the development bias voltage (Vdc) and the fog removal potential are set to be −500 V, −300 V, and 200 V, respectively. Here, the fog removal potential denotes potential difference between the surface potential (Vd potential) at the non-image part of the photosensitive drum and the development bias voltage (Vdc).

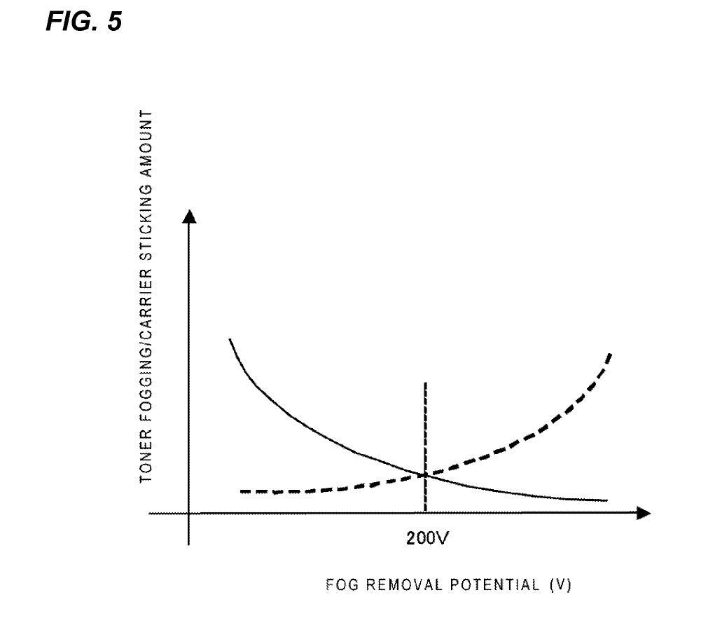

Next, relation between the fog removal potential and respective toner fogging and carrier sticking occurring on the photosensitive drum will be described with reference to FIG. 5. In FIG. 5, the horizontal axis denotes the fog removal potential and the vertical axis denotes amounts of toner fogging and carrier sticking. In FIG. 5, the toner fogging amount is indicated by a solid line and the carrier sticking amount is indicated by a broken line.

As illustrated in FIG. 5, the toner fogging is worsened as the fog removal potential becomes small. On the contrary, the carrier sticking amount becomes large as the fog removal potential becomes large. This is because the toner becomes more likely to be developed onto the photosensitive drum with decrease of the fog removal potential owing to negative polarity of the toner charging and the carrier becomes more likely to be developed onto the photosensitive drum with increase of the fog removal potential owing to positive polarity of the carrier. Accordingly, when the fog removal potential is set to be small, toner fogging is to occur at a white background portion although poor image due to carrier sticking can be suppressed. Here, based on FIG. 5, the fog removal potential is set to 200 V to suppress both toner fogging and carrier sticking.

In the following, description will be made on white spots caused by carrier sticking occurring at the photosensitive drum.

When green image formation is performed with the above-structured image forming apparatus, white spots occurred owing to transfer failure of a cyan toner image. As described herein, a possible cause is as follows. First, carrier occurring at the magenta image forming portion (i.e., the second station) was stuck onto a yellow toner image which was formed at the yellow image forming portion (i.e., the first station). Subsequently, when the cyan toner image was transferred onto the yellow toner image at the cyan image forming portion (i.e., the third station), transfer failure occurred with the cyan toner corresponding to a position at which the stuck carrier presented.

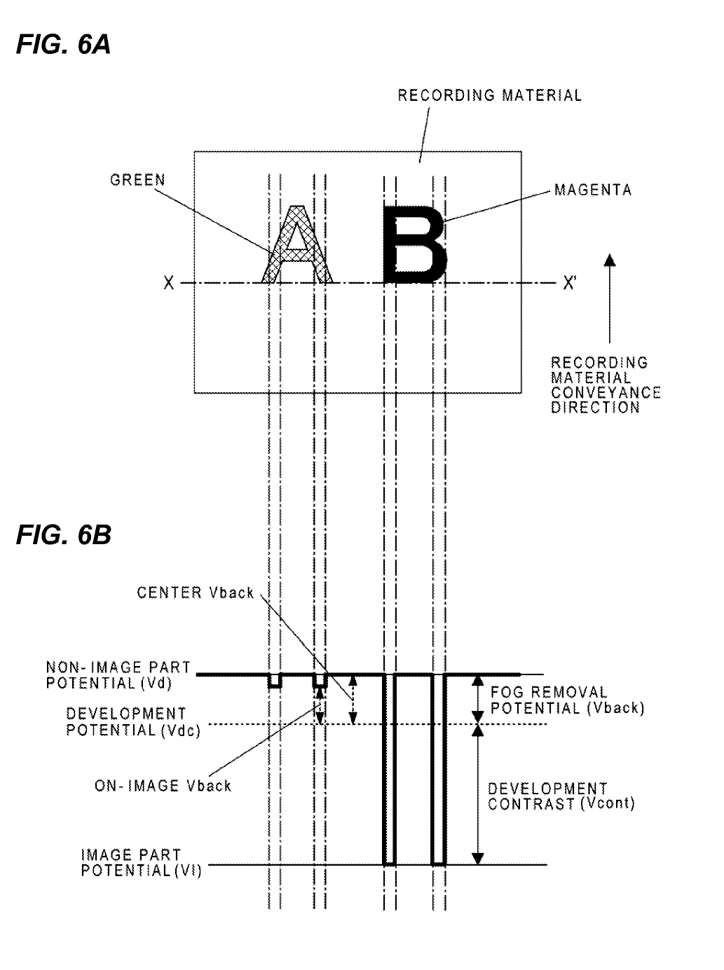

In the present embodiment, to suppress occurrence of the above-mentioned white spots, surface potential of a part (i.e., a first area) overlapping the cyan toner image to be formed at the cyan image forming portion (i.e., a second image forming portion) at the downstream of belt movement direction is set to be smaller than surface potential of another part (i.e., a second area) among surface potential of a non-image part of the photosensitive drum disposed to the magenta image forming portion (i.e., a first image forming portion) which does not form the green image. That is, the fog removal potential (i.e., On-image Vback) of the part overlapping the cyan toner image (i.e., the part corresponding to the green image) to be formed at the cyan image forming portion at the downstream side is set to be smaller than the fog removal potential (i.e., Center Vback) of another part among the fog removal potential (Vback) of the magenta image forming portion. In the following, detailed description will be made with reference to FIGS. 6A and 6B.

FIG. 6A illustrates an aspect to perform image formation of “A” in green (by superimposing yellow toner and cyan toner) and “B” in magenta (as single color of magenta toner) on a recording material. Here, occurrence of carrier sticking at the magenta image forming portion corresponding to the green image is suppressed by utilizing photosensitive drum potential as illustrated in FIG. 6B for developing an image at a line X-X′ on the recording material with magenta toner.

Similarly to FIG. 3, FIG. 6B schematically illustrates the potential (Vl) at the image part and the potential (Vd) at the non-image part on the photosensitive drum and the value of the development bias (i.e., the development potential Vdc) to be applied to the development roller, respectively. As the aspect of magenta toner development at the line X-X′ being illustrated in FIG. 6B, exposure potential (i.e., potential of the image part) of the image “B” to be developed with magenta toner is Vl as the relation between FIGS. 6A and 6B. Meanwhile, the potential (Vd) of the non-image part corresponding to the part of “A” at which the image formation is performed in green is set to be smaller than the potential of another non-image part. With reference to FIGS. 6A and 6B, the fog removal potential is set to be small only at the part corresponding to “A” of FIG. 6B by varying the potential to be closer to the development potential (Vdc) compared to the potential (Vd) of another non-image part. The fog removal potential of the portion having smaller fog removal potential than another non-image portion is denoted by On-image Vback. Further, the fog removal potential of the non-image part other than parts corresponding to the “A” is denoted by Center Vback. Here, the On-image Vback is set to be smaller than the Center Vback by 20 V by setting the On-image Vback and the Center Vback to be 180 V and 200 V, respectively. The On-image Vback may be formed by exposing with the exposure device 7 to reduce the photosensitive drum potential after the photosensitive drum is evenly charged by the charging roller 3.

When the fog removal potential of the non-image part of the magenta image forming portion is lowered as in the present embodiment, there is a possibility that color quality variation occurs at the green image as fogged toner being transferred onto the yellow toner image owing to easily occurring toner fog. However, even when magenta toner fogging occurs, the color quality variation due to the toner fogging is extremely slight since cyan toner is superimposed at the cyan image forming portion at the downstream thereof.

As described above, the surface potential of the non-image part of the photosensitive drum at the magenta image forming portion (i.e., the upstream station) as the first image forming portion is set to be smaller only at the part corresponding to the toner image to be formed at the cyan image forming portion (i.e., the downstream station) as the second image forming portion at the downstream thereof than that at another part. Accordingly, occurrence of carrier sticking is reduced on the photosensitive drum of the magenta image forming portion. In this manner, it is possible to provide an image forming apparatus capable of suppressing decrease in image quality due to carrier sticking and performing stable image formation over a long period of time.

The present embodiment is exemplified with the case that the image formation is performed by superimposing yellow and cyan. However, it is not limited to the above case. It is possible to obtain the similar effect by setting the fog removal potential of a non-image part of an upstream station to be smaller only at a part corresponding to a toner image of a downstream station, for example, even when image formation is performed in a single color of magenta, cyan, or black, or image formation is performed by superimposing magenta and cyan.

### Second Embodiment

Next, a second embodiment will be described. Here, the basic structure and operation of an image forming apparatus of the present embodiment are the same as those of the above-mentioned first embodiment. Accordingly, the same numeral is given to an element having the same or corresponding function and structure, and detailed description thereof will not be repeated. Characteristic points of the present embodiment will be described below.

In the above-mentioned first embodiment, the fog removal potential of the magenta station is set to be smaller at the position corresponding to the green image than that at another position. However, when toner fogging becomes likely to occur owing to increase of magenta toner density, for example, there may be an infrequent case that color quality of the output green image is varied caused by superimposing of magenta fog toner onto the yellow toner image.

In the present embodiment, a magnetic permeability sensor (i.e., a toner density detection sensor) as a toner density detection unit is disposed to each development device of yellow, magenta, cyan, and black. Then, the On-image Vback is set to be smaller than the Center Vback as described in the first embodiment only when it is determined that carrier sticking remarkably occurs according to a detection result of the magnetic permeability sensor. Details will be described below.

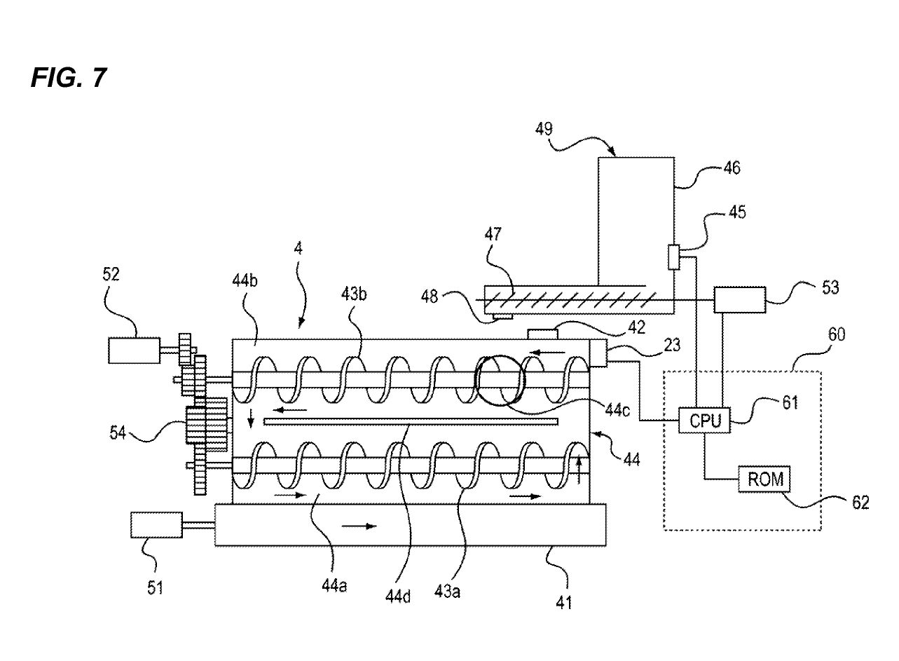

As illustrated in FIG. 7, each development device 4 of the present embodiment has a magnetic permeability sensor 42 attached into the agitation room 44b as the toner density detection unit to detect toner density (i.e., mixture ratio between toner and carrier) of the developer. In the present embodiment, the magnetic permeability sensor 42 is arranged at a side wall of the development container 44 at the upstream side from the toner supplement port 44c of the developer conveyance direction in the agitation room 44b. Assuming that the position to which toner is supplemented from the toner supplement device 49 is the most upstream side of the developer circulation, the position to which the magnetic permeability sensor 42 is attached is to be the most downstream side. That is, the magnetic permeability sensor 42 is located to be capable of detecting the developer density in a state of the most promoted agitation.

Next, description will be made on toner supplement control with an inductance detection method which is adopted in the present embodiment.

As described above, the toner in the developer container 44 is decreased with image forming operation. Accordingly, the toner density in the developer is decreased. In the present embodiment, the magnetic permeability sensor 42 is arranged at the development container 44 of the development device 4 and the magnetic permeability of the developer is detected by the magnetic permeability sensor 42 so as to detect the toner density of the developer in the development container 44. When the toner density of the developer is small, the magnetic permeability of the developer becomes large owing to increase of the carrier ratio, so that output level of the magnetic permeability sensor 42 becomes large.

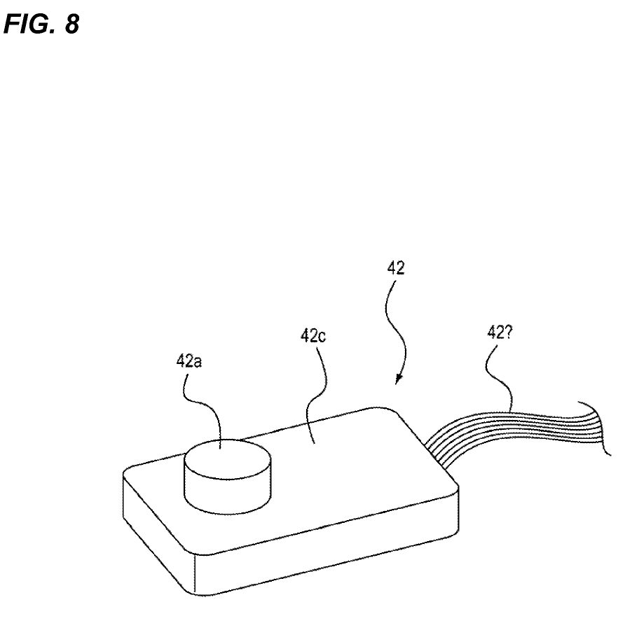

As illustrated in FIG. 8, the magnetic permeability sensor 42 is formed into an integrated shape as a detection head 42a is cylindrically mounted on a sensor body 42c. Then, communication of the detection signal is performed via signal lines 42b for input-output with the CPU 61 of the engine controlling portion 60 which is disposed to the image forming apparatus body. A detection transformer is embedded inside of the detection head 42a. The detection transformer includes three winding wires in total being one primary winding wire and two secondary winding wires of a reference winding wire and a detection winding wire. The detection winding wire is located at the ceiling side of the detection head 42a and the reference winding wire is located at the rear side of the detection head 42a sandwiching the primary winding wire. When current having a signal of a constant waveform is output to the primary winding wire from a generator arranged in the sensor body 42c, current having a signal of a certain waveform flows respectively through the two secondary winding wires of the reference winding wire and the detection winding wire owing to electromagnetic induction. The degree of density of magnetic material presenting at the ceiling side of the detection head 42a is detected by determining the constant waveform signal from the generator at that time and the certain waveform signal of the current flowed from the detection winding wire owing to electromagnetic induction with a comparison circuit which is disposed in the sensor body 42c.

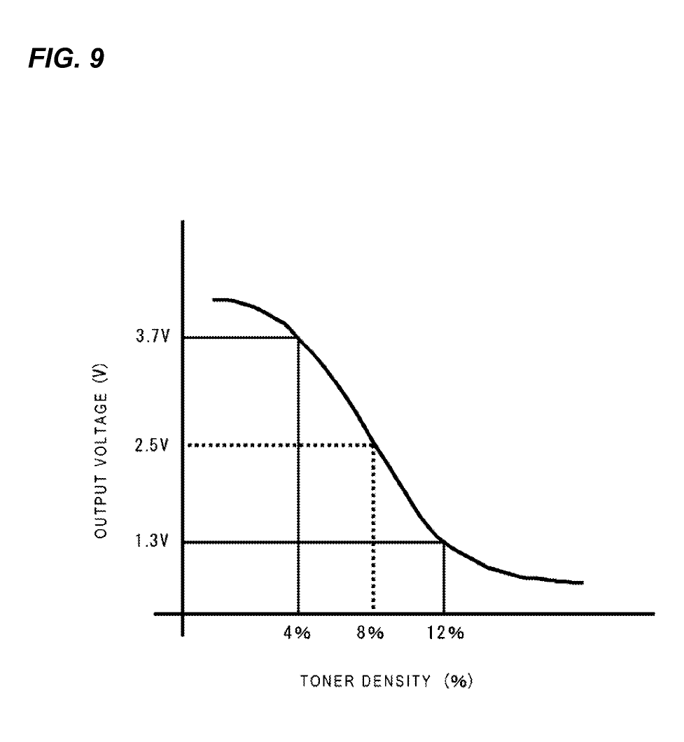

In the following, relation between the toner density of the developer and the output of the magnetic permeability sensor 42 will be described. FIG. 9 illustrates an example of the output characteristics of the magnetic permeability sensor 42. In FIG. 9, the horizontal axis denotes the toner density and the vertical axis denotes output voltage.

In an example of FIG. 9, the output voltage value is saturated to be a large value in a range of small toner density. The sensor output is gradually decreased with increase of the toner density, and then, the output voltage value is saturated to be a small value in a range of further large toner density. In the present embodiment, adjustment is performed so that the detection output voltage value of the magnetic permeability sensor 42 is to be 2.5 V when the toner density is a normal value of 8% (i.e., weight % being the same in the following). When the voltage value is in the vicinity of 2.5 V, the detection output value is varied approximately linearly against the toner density. Here, the target signal value of the magnetic permeable sensor is varied to be set at an appropriate target value according to usage situations and usage circumstances.

As described above, the density of the developer in the development device 4 is detected by the magnetic permeability sensor 42. Then, the toner density in the development container 44 is to be maintained at constant as the toner supplement device 49 which accommodates toner for supplement being driven based on the detection result. That is, the CPU 61 determines rotation time of the motor 53 based on the detection result of the magnetic permeability sensor 42, so that the motor 53 is rotated only during the time. The ROM 62 (or the inside of the CPU 61) stores information to acquire a toner amount to be supplemented to the development device 4 from the detection output of the magnetic permeability sensor 42 as table data based on the relation between the detection output of the magnetic permeability sensor 42 and the toner density of the developer as illustrated in FIG. 9. Accordingly, the CPU 61 is capable of requiring revolution speed of the toner supplement screw 47 from the above information and controlling the toner supplement amount, and the table data indicating correspondence relation between the rotation time of the motor 53 and the amount of toner to be supplemented as described above.

Normally, in the toner supplement control of the induction detection method, the rotation speed of the toner supplement screw 47 is acquired and the toner supplement is performed each time when image forming operation is performed against one recording material P.

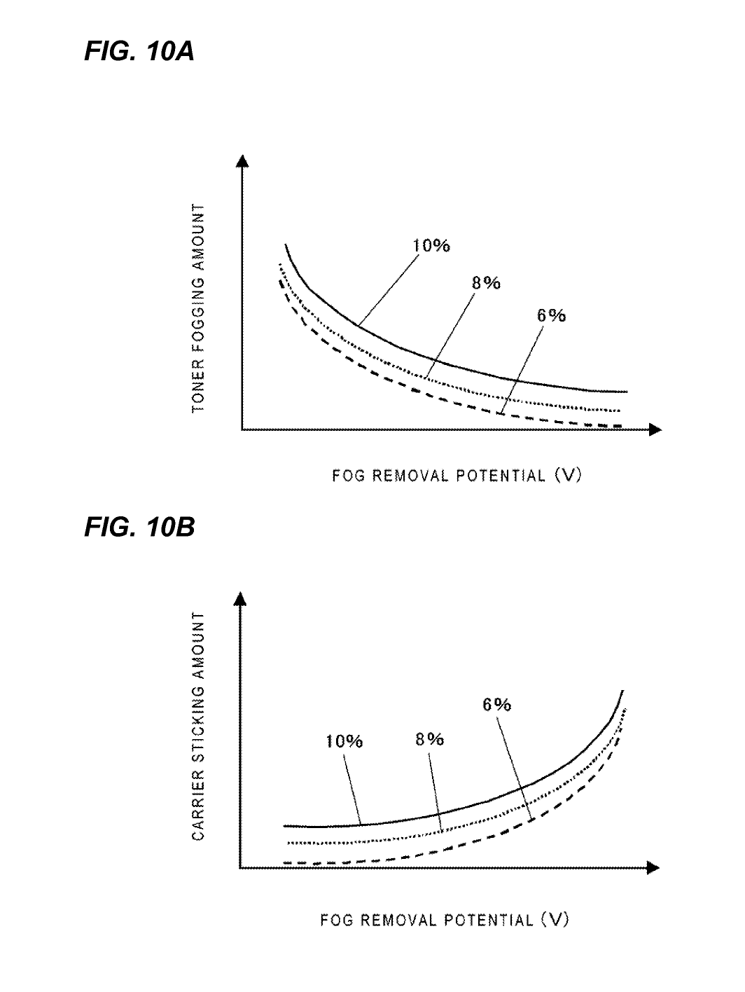

Next, the relation between the fog removal potential and the respective amounts of toner fogging and carrier sticking when the toner density is varied will be described with reference to FIGS. 10A and 10B. FIG. 10A indicates the relation between the fog removal potential and the toner fogging amount when the toner density is varied. FIG. 10B indicates the relation between the fog removal potential and the carrier sticking amount when the toner density is varied. In FIGS. 10A and 10B, the toner density is indicated by 10%, 8%, and 6%, respectively. As indicated in FIGS. 10A and 10B, the toner fogging amount is increased and the carrier sticking amount is decreased with increase of the toner density. On the contrary, the toner fogging amount is decreased and the carrier sticking amount is increased with decrease of the toner density.

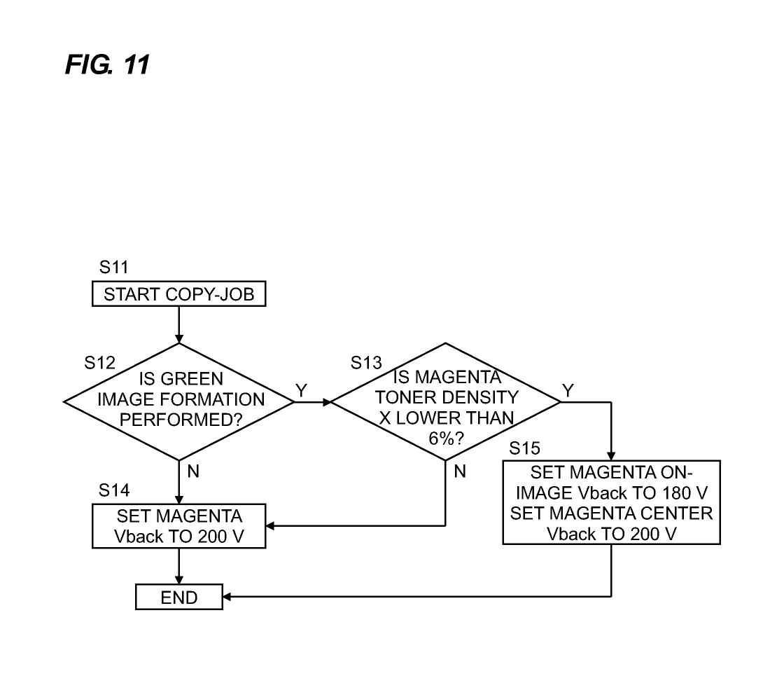

In the following, a determination flow of setting the On-image Vback of the present embodiment will be described with reference FIG. 11. Here, description is made as exemplifying a case of performing green image formation. However, color of the image to be formed in not limited thereto.

When green image formation is performed (S12) after a copy-job is started (S11), it is determined that carrier sticking does not occur when the detection result of the magenta toner density X is 6% or higher (S13). Then, the fog removal potential of magenta is set to be 200 V (S14). On the other hand, when the detection result of the magenta toner density X is lower than 6% (S13), it is determined that carrier sticking occurs. Then, On-image Vback is set to be 180 V and Center Vback is set to be 200 V (S15), so that the surface potential (i.e., On-image Vback) of a non-image part to be overlapping the toner image is set to be smaller than the surface potential (i.e., Center Vback) of a non-image part of another part by 20 V.

As described above, when the toner density of the upstream station (i.e., the first image forming portion) is lowered than a predetermined value, the fog removal potential of the non-image part of the upstream station is set to be smaller only at the part corresponding to the toner image of the downstream station (i.e., the second image forming portion) than that at another part. As a result, it is possible to suppress decrease in image quality due to carrier sticking and perform stable image formation over a long period of time.

The present embodiment is exemplified with the case that the image formation is performed by superimposing yellow and cyan. However, it is not limited to the above case. It is possible to obtain the similar effect by setting the fog removal potential of a non-image part of an upstream station to be smaller only at a part corresponding to a toner image of a downstream station, for example, even when image formation is performed in a single color of magenta, cyan, or black, or image formation is performed by superimposing magenta and cyan.

### Third Embodiment

Next, a third embodiment will be described. Here, the basic structure and operation of an image forming apparatus of the present embodiment are the same as those of the above-mentioned first and second embodiments. Accordingly, the same numeral is given to an element having the same or corresponding function and structure and detailed description thereof will not be repeated. Characteristic points of the present embodiment will be described below.

In the first and second embodiments, the fog removal potential of the magenta station at the portion corresponding to the green image is set to be small. Here, the fog removal potential of the magenta station is lessened even when a highlight green image is formed, for example. Accordingly, when toner fogging becomes likely to occur owing to increase of magenta toner density, for example, the fog toner of magenta overlaps the yellow toner image. Therefore, there may be an infrequent case that color quality of the highlight green image is varied although color variation hardly occurs at a high density part of the green image.

Here, when highlight green image formation is performed, the carrier occurring at the magenta station is unlikely to be transferred onto the yellow toner image owing to small toner amount of the yellow toner image. In addition, an amount of cyan toner to be transferred is small as well in the case of the highlight. Accordingly, transfer failure of cyan toner is unlikely to occur even when carrier presents on the yellow toner image.

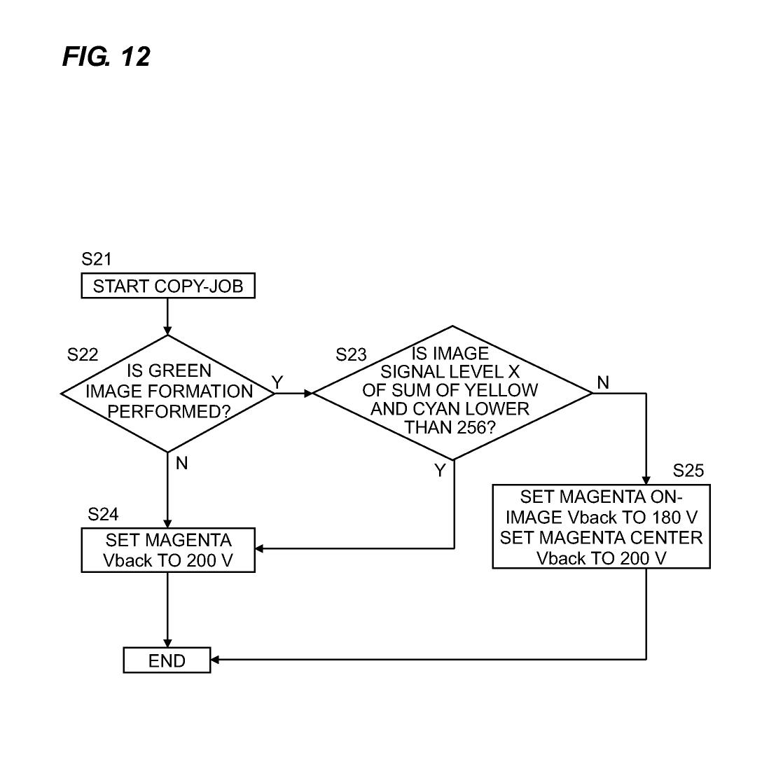

In the present embodiment, when high density green image formation is to be performed, On-image Vback of the magenta station is set to be smaller than Center Vback as described in the first embodiment. On the other hand, when the highlight green image formation is to be performed, the fog removal potential of the magenta station is set to be equal to Center Vback. That is, when image density of the green image is equal to a predetermined value or higher, the surface potential (i.e., On-image Vback) of a part overlapping the toner image to be formed at the cyan station is set to be smaller than the surface potential (i.e., Center Vback) of another part among the surface potential of a non-image part of the photosensitive drum disposed to the magenta station. On the other hand, when the image density of the green image is less than the predetermined value, the surface potential of the non-image part of the photosensitive drum disposed to the magenta station is set to be the same as the surface potential (i.e., Center Vback) in the normal image formation. In the following, detailed description is made with reference to a flowchart of FIG. 12. Here, FIG. 12 exemplifies a case that the predetermined value is a sum of image signal levels (e.g., 256 level). However, it is not limited to the above case.

In the present embodiment, the gradation number of the green image is calculated from an output signal level of an image signal processing circuit. The present embodiment adopts 256 gradations of levels of 0 to 255 for each of yellow, magenta, cyan, and black. A green image is formed by superimposing toner images of yellow and cyan. A solid green image is formed by superimposing a toner image of yellow at 255 level and a toner image of cyan at 255 level.

As illustrated in FIG. 12, when green image formation is performed (S22) after a copy-job is started (S11), the fog removal potential of magenta is set to be 200 V (S24) when a sum of image signal levels of yellow and cyan is lower than 256 level (S23). On the other hand, when a sum of the image levels of yellow and cyan is 256 level or higher (S23), On-image Vback is set to be 180 V and Center Vback is set to be 200 V (S25). Consequently, Vback on an image is set to be smaller by 20 V.

As described above, when an image of which image density is equal to or higher than a predetermined value is to be formed at the downstream station (i.e., the second image forming portion), the fog removal potential of the non-image part of the upstream station (i.e., the first image forming portion) is set to be small only at the part corresponding to the high density image of the downstream station. As a result, it is possible to suppress decrease in image quality due to carrier sticking and perform stable image formation over a long period of time.

The present embodiment is exemplified with the case that the image formation is performed by superimposing yellow and cyan. However, it is not limited to the above case. It is possible to obtain the similar effect by setting the fog removal potential of a non-image part of an upstream station to be smaller only at a part corresponding to a high density image of a downstream station when high density image formation at the downstream station is performed, for example, even when image formation is performed in a single color of magenta, cyan, or black, or image formation is performed by superimposing magenta and cyan.

### Other Embodiments

The above-mentioned embodiments exemplify the configuration in which four image forming units are adopted to form multi-color images. However, not limited to this, the number for use thereof may be appropriately set as required.

Further, in the above-mentioned embodiments, a laser scanner is adopted as the exposure unit. However, not limited to this, it is also possible to adopt an LED array, for example.

Further, in the above-mentioned embodiments, a printer is adopted as the image forming apparatus as an example. However, the present invention is not limited to this. For example, it is also possible to adopt another image forming apparatus such as a copying machine and a facsimile device or another image forming apparatus such as a multi-function machine in which the above functions are combined. Further, it is also possible to adopt an image forming apparatus to superimpose toner images of respective colors in sequence onto a recording material which is borne to a recording material bearing member utilizing the recording material bearing member without utilizing an intermediate transfer member. The similar effects can be obtained by applying the present invention to those image forming apparatuses.

Further, each of the above-mentioned embodiments exemplifies an image forming apparatus in which toner images of respective colors are transferred as being superimposed to an intermediate transfer member as utilizing the intermediate transfer member and the toner image borne to the intermediate transfer member is transferred to a recording material at once with the intermediate transfer member (i.e., the intermediate belt) as the transfer-receiving member. However, it is not limited to this. For example, in an image forming apparatus in which toner images of respective colors are sequentially superimposed on a recording material which is borne to a recording material bearing member, the recording material is to be the transfer-receiving member. The similar effects can be obtained by applying the present invention even to such an image forming apparatus.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims the benefit of Japanese Patent Application No. 2010-216604, filed Sep. 28, 2010, which is hereby incorporated by reference herein in its entirety.

What is claimed is:

1. An image forming apparatus, comprising:
a plurality of image forming portions, each of which respectively include an image bearing member, an electrostatic image forming device which forms an electrostatic image on a surface of the image bearing member, a development device that develops the electrostatic image of the image bearing member by utilizing developer having toner and carrier, and a transfer device that transfers a toner image developed by the image bearing member to a transfer-receiving member, the plurality of image forming portions including a first image forming portion and a second forming portion that is arranged at a downstream side of an image conveyance direction from the first image forming portion; and
a controlling portion that is capable of performing a mode to control potential of the image bearing member at the first image forming portion so that an absolute value of a surface potential of at least a part of a first area is to be smaller than that of a surface potential of a second area, wherein the first area denotes an area to which a toner image is not to be formed at the first image forming portion and corresponding to an area to which a toner image is to be formed at the second image forming portion, and that the second area denotes an area corresponding to an area to which any toner image is not formed at both the first image forming portion and the second image forming portion among the surface of the image bearing member at the first image forming portion.

2. The image forming apparatus according to claim 1,
wherein the first image forming portion includes a toner density detection unit that detects toner density in the development device, and
the controlling portion performs a mode that when the toner density is detected by the toner density detection unit to be lower than a predetermined value.

3. The image forming apparatus according to claim 1,
wherein at least a part of the first area is an area at which an image density of an image to be formed at the second image forming portion is equal to predetermined density or higher.
